(19) United States
(12) Patent Application Publication
(10) Pub. No.: US 2025/0217266 A1
(43) Pub. Date: Jul. 3, 2025

(54) VALIDATING CODE GENERATED BY ARTIFICIAL INTELLIGENCE USING ABSTRACT SYNTAX TREES

(71) Applicant: INTERNATIONAL BUSINESS MACHINES CORPORATION, ARMONK, NY (US)

(72) Inventors: ANDREW C. M. HICKS, HIGHLAND, NY (US); MICHAEL GAGLIARDI, SOMERSET, MA (US); RYAN LO, POUGHKEEPSIE, NY (US)

(21) Appl. No.: 18/398,388

(22) Filed: Dec. 28, 2023

(51) Int. Cl. G06F 11/36

(52) U.S. Cl. CPC G06F 11/3608

(57) ABSTRACT

Validating code generated by artificial intelligence using abstract syntax trees includes generating, by an artificial intelligence (AI) language model, output source code based on input source code; determining an equivalency mapping between a first abstract syntax tree (AST) constructed for the input source code and a second AST constructed for the output source code; and indicating, based on the equivalency mapping, a validation result for the output source code.

### BACKGROUND

The present disclosure relates to methods, apparatus, and products for validating code generated by artificial intelligence using abstract syntax trees. Migrating the functionality of legacy source code to a more modern programming language can increase the maintainability and readability of the source code as well as improve system performance. However, such a migration is an arduous task that can include writing, testing, validating, and debugging massive amounts of code.

### SUMMARY

According to embodiments of the present disclosure, various methods, apparatuses and products for validating code generated by artificial intelligence using abstract syntax trees are described herein. In some aspects, an artificial intelligence (AI) language model is used to remap application source code from an original codebase to a target codebase while maintaining the same functionality. In some aspects, abstract syntax trees (ASTs) are used to validate the translation of the original application source code to the AI-generated source code. An equivalency mapping between the AST of the input source code and the AST of the output source code indicates the translation accuracy of the AI-generated code. A validation result can be identified from the degree of equivalency exhibited in the equivalency mapping. In some aspects, when the ASTs are found to include non-equivalencies, the AI language model can be prompted to regenerate the code. In some aspects, improvements to the language model can be measured using AST comparison as a validation metric. Thus, the AST comparison facilitates code validation when migrating from an original codebase to a new codebase, such as from a first programming language to a second programming language or from a legacy system to a modernized system, using AI-generated code.

In a particular embodiment, a method of validating code generated by artificial intelligence using abstract syntax trees includes generating, by an artificial intelligence (AI) language model, output source code based on input source code. The method also includes determining an equivalency mapping between a first abstract syntax tree (AST) constructed for the input source code and a second AST constructed for the output source code. The method further includes indicating, based on the equivalency mapping, a validation result for the output source code. In some examples, the input source code is implemented in a first programming language and the output source code is implemented in a second programming language that is different from the first programming language. In this way, it can be determined whether the ASTs of the input source code and the output source code are functionally equivalent, even though the ASTs may exhibit a different structure. All permutations of core functions can be relationally mapped for AST comparison.

In some variations, the validation result indicates a validation failure when the equivalency mapping indicates at least one nonequivalent element in at least one of the first AST and the second AST, and the validation result indicates a validation success when the equivalency mapping indicates an equivalency for all elements of the first AST and the second AST. In other variations, the validation result indicates a degree of equivalency. The aim of the code translation is that the AI-generated output source code has an AST that is equivalent to the AST of the input source code, thus the validation result may be pass/fail; however, the degree of equivalency is useful in assessing the progress of the AI language model before and after retraining, and for determining whether the identified non-equivalencies impart a change in functionality.

In some variations, determining an equivalency mapping between a first AST constructed for the input source code and a second AST constructed for the output source code includes partitioning the first AST and the second AST into subtrees and identifying equivalencies between the subtrees of the first AST and the second AST. In this way, complex ASTs constructed from hundreds of thousands, if not millions, of lines of code are unitized for comparison such that independent subtrees of one AST are reordered to match the structure of the other AST to facilitate comparison and determine equivalency.

In some variations, identifying equivalencies between the subtrees of the first AST and the second AST includes identifying one or more equivalent permutations of a first subtree of one AST and determining that a second subtree in another AST matches one of the one or more equivalent permutations. In some examples, the one or more equivalent permutations of the first subtree are generated by one or more of changing variable names and reordering independent statements. In this way, subtrees of different shapes but identical paths can be used to determine whether one tree is functionally equivalent to another subtree. This allows a rearrangement of elements in one AST to match the shape of the other AST.

In some variations the method also includes indicating a location of a nonequivalent element found in at least one of the input source code and the output source code. In this way, software engineers can analyze the translation error and determine whether the error (i.e., indicated by a non-equivalency in the AST) is a critical error. Engineers can further use the information to identify aspects for retraining the AI language model.

In some variations the method also includes regenerating, by the AI language model in response to the validation result, new output source code from the input source code. In this way, the AI language module can iteratively regenerate the output source code until an acceptable validation score is achieved.

In some variations the method also includes determining, subsequent to retraining the AI language model, a second validation result for regenerated output source code. In these variations, the method further includes quantifying an improvement of the AI language model based on at least the validation result and the second validation result. In this way, the accuracy and reliability of the AI language model can be assessed and the result of retraining the AI language model can be measured.

In some aspects, an apparatus may include a processing device; and memory operatively coupled to the processing device, wherein the memory stores computer program instructions that, when executed, configure the processing device to perform the above-described operations. In some aspects, a computer program product comprising a computer readable storage medium may store computer program instructions that, when executed, configure a computer to perform above-described operations.

### BRIEF DESCRIPTION OF THE DRAWINGS

FIG. 1 sets forth a block diagram of an example computing environment for validating code generated by artificial intelligence using abstract syntax trees in accordance with some embodiments of the present disclosure.

FIG. 2 sets forth a flowchart of an example method for validating code generated by artificial intelligence using abstract syntax trees in accordance with some embodiments of the present disclosure.

FIG. 3 sets forth a flowchart of another example method for validating code generated by artificial intelligence using abstract syntax trees in accordance with some embodiments of the present disclosure.

FIG. 4 sets forth a flowchart of another example method for validating code generated by artificial intelligence using abstract syntax trees in accordance with some embodiments of the present disclosure.

FIG. 5 sets forth a flowchart of another example method for validating code generated by artificial intelligence using abstract syntax trees in accordance with some embodiments of the present disclosure.

FIG. 6 sets forth a flowchart of another example method for validating code generated by artificial intelligence using abstract syntax trees in accordance with some embodiments of the present disclosure.

FIG. 7 sets forth a flowchart of another example method for validating code generated by artificial intelligence using abstract syntax trees in accordance with some embodiments of the present disclosure.

### DETAILED DESCRIPTION

In the world of software development, the need for modernizing a codebase from one programming language to another has become increasingly prevalent. For example, the source code for an application may be migrated from a legacy programming language (e.g., COBOL) to a modern programming language (e.g., Java). The motivation for such a migration may be to facilitate easier maintenance and readability of the source code, increase security and error handling, improve software and/or hardware performance, and other advantages that will be recognized by those of skill in the art.

In accordance with the present disclosure, artificial intelligence (AI) is used to port or migrate source code of an application to a different programming language. A large language model (LLM) is trained on datasets that include massive amounts of source code to develop generative AI that can output source code based on an input or prompt. That is, the AI language model is used to generate new source code based on an input of original source code. For example, an AI language model may be given a prompt such as “Generate Java code that achieves the same objectives as the following COBOL code,” where the legacy COBOL source code is provided as an input. In response, the AI language model may output, ideally, AI-generated Java source code that performs the same functions and produces the same output as the legacy.

However, migrating a codebase to a new language introduces a significant challenge in ensuring the accuracy and functionality of the translated code, especially when leveraging AI for automated translations. The difficulty lies in the validation of AI-generated code translations and ascertaining whether the translated code preserves the intended logic, functionality, and structure of the original code. The inherent complexity of programming languages, coupled with the ways in which developers express their logic, poses a challenge in reliably validating the correctness and similarity of AI-generated translations. Further, validating output source code translated from input source code requires an analysis of hundreds of thousands if not millions of lines of code.

The present disclosure addresses the challenges associated with validating the accuracy of AI-generated code translations, with a specific focus on enhancing the reliability and maintainability of automated code translation through the comparison of abstract syntax trees (ASTs). In accordance with the present disclosure, ASTs are leveraged to validate AI-translated code by breaking input source code and AI-generated source code down into elements such as if statements, loops, function declarations, variable declarations, etc. that are represented in by an AST. Both ASTs are then traversed and the types and properties of each node are compared to identify functional equivalence. Programmatic fuzzing and complexity blurring are applied to shapes in the ASTs so that all permutations of core function in the program can be relationally mapped when doing an AST comparison. In some examples, the ASTs are unitized by breaking the ASTs into subtrees for direct comparison. In some examples, a validation result identifies overfitting and underfitting in the AI-generated code and this metric is used for an analysis of translation accuracy.

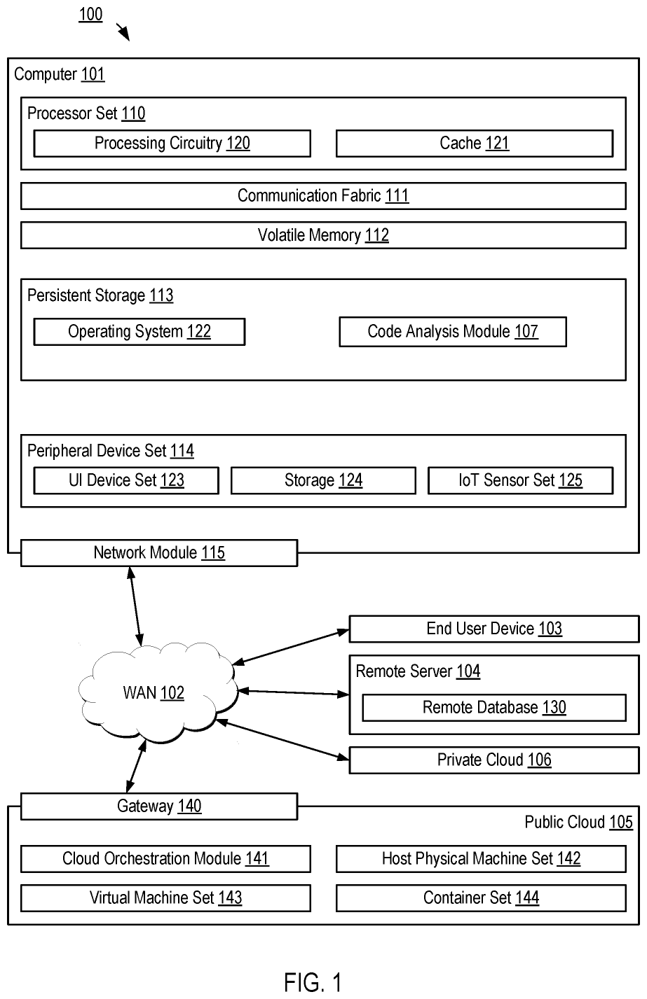

With reference now to FIG. 1, shown is an example computing environment according to aspects of the present disclosure. Computing environment 100 contains an example of an environment for the execution of at least some of the computer code involved in performing the various methods described herein, such as the code analysis module 107. In addition to the code analysis module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code analysis module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in code analysis module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in code analysis module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

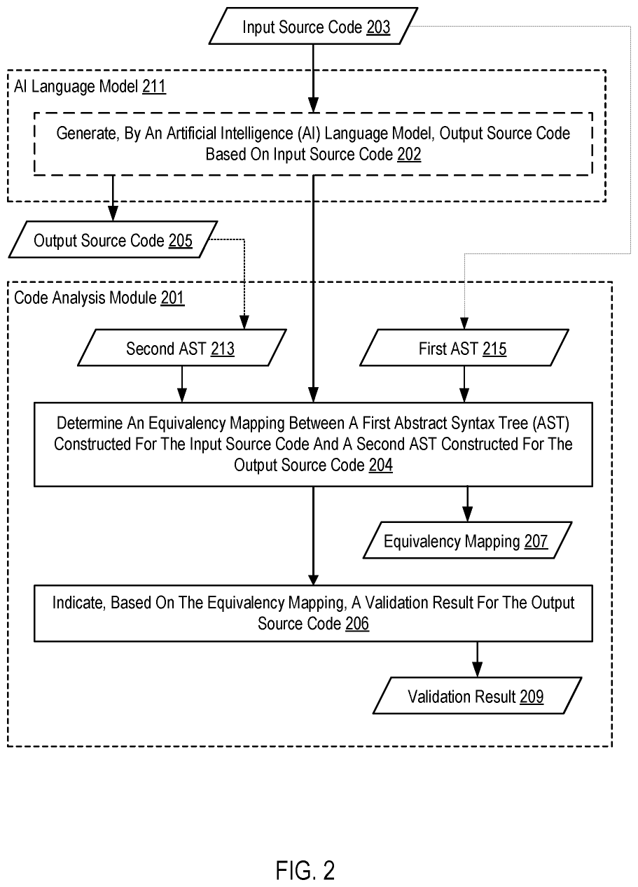

For further explanation, FIG. 2 sets forth a flowchart of an example method of validating code generated by artificial intelligence using abstract syntax trees in accordance with some embodiments of the present disclosure. The method of FIG. 2 may be performed, for example, by a code analysis module 201 such as the code analysis module 107 of FIG. 1. In some examples, the code analysis module 201 may be implemented as a process or service that includes an AI language model that generates output source code from input source code. In other examples, the code analysis module 201 may be implemented as part of a process or service separate from a process or service that includes an AI language model. In further examples, the code analysis module 201 may be implemented as part of a process or service monitors the quality of the AI language model to assess whether retraining of the AI language model is appropriate or successful.

The method of FIG. 2 includes generating 202, by an artificial intelligence (AI) language model 211, output source code 205 based on input source code 203. The AI language model 211 may be trained on massive datasets of original source code in a first programming language that has been remapped to source code in a different programming language. As such, the AI language model 211 is configured to autonomously translate a block of input source code in one programming language to a block of output source code in a different programming language. In some examples, the input source code and the output source code reflect a migration of source code of an application from a first programming language (e.g., a legacy codebase) to a second programming language (e.g., a modern codebase). For example, the input source code may include legacy source code written in an older programming language (e.g., COBOL), whereas the output source code may be implemented in a modern programming language (e.g., Java); however, both the input source code and the output source code are intended to achieve the same objectives, provide the same interfaces, and produce the same output.

In some examples, the output source code 205 is generated by prompting the AI language model to generate output source code based on the input source code 203. For example, the AI language model may be prompted “Generate Java source code from block A of COBOL source code” where block A is provided as the input source code. In response, the AI language model generates Java source code that is intended to provide the same interfaces, perform the same functions, and generate the same outputs as the original COBOL source code.

The method of FIG. 2 also includes determining 204 an equivalency mapping 207 between a first AST 213 constructed for the input source code 203 and a second AST 215 constructed for the output source code 205. The code analysis module 201 determines 204 the equivalency mapping by identifying and AST 213 for the input source code and an AST 215 of the output source code. These ASTs may be constructed by the code analysis module 201 or the code analysis module 201 may employ ASTs that are constructed by software development utility or compiler.

An AST is a hierarchical tree data structure that represents the syntactic structure of source code in a programming language. The AST abstracts the details of the concrete syntax, which contains information not necessary for understanding the program's semantics. An AST focuses on the relationships between language elements, such as expressions, statements, and declarations while also abstracting away details like parentheses, braces, and other punctuation. An AST is implemented as a tree of nodes that represent the different syntactic constructs in the source code (e.g., if statements, loops, function and variable declarations, assignments). These nodes are organized in a hierarchical structure, reflecting the nested and hierarchical nature of the source code. ASTs provide a concise and abstract view of code that facilitates automated static code analysis. In accordance with the present disclosure, a comparison of the ASTs of the input source code and the AI-generated output source code are used to validate the output source code as functionally equivalent to the input source code.

Here equivalency between two ASTs means that for every node in a first tree there is an equivalent node in the second AST, and for every edge between two nodes in the first tree there is an edge between two equivalent nodes in the second AST. The equivalency of two ASTs does not require that the trees exhibit the same order where the order of independent statements, or the order of independent paths, does not alter the functionality of the code. In this disclosure the terms ‘node’ and ‘element’ of an AST may be used interchangeably.

In some examples, the code analysis module 201 determines 204 an equivalency mapping 207 by identifying whether there is, for every node and edge in the first AST, an equivalent node and edge in the second AST. In some implementations, the code analysis module 201 identifies equivalent nodes by walking each AST 213, 215 and comparing the type and properties of each node. For example, the type may be an abstract type that is not syntax-dependent, such as an if statement, a loop (e.g., ‘for’ or ‘do . . . while’), a function declaration, a variable declaration, and so on. The properties of each node can include the degree of the node and the set of nodes to which that node is connected. In some cases, the nodes of the AST may not be labeled with information indicating a type or other non-observable properties. In such cases, determining an equivalency mapping can be carried out by matching patterns within one AST to patterns within the other AST.

In some examples, the code analysis module 201 unitizes each AST 213, 215 by decomposing the AST into subtrees for comparison, as will be explained in more detail below. In these examples, the code analysis module 201 determines 204 an equivalency mapping 207 by identifying subtrees in one AST that match to subtrees in the other AST. Once equivalent subtrees are identified, independent subtrees can be rearranged as needed to reconstruct the AST 215 of the output source code 205 to match the AST 213 of the input source code 203.

In some examples, the code analysis module 201 determines 204 the equivalency mapping 207 by creating a data structure that indicates an equivalency determination of for each element. An equivalency is recorded when it is identified that an element of the second AST is equivalent to an element of the first AST. A non-equivalency is recorded for an element in an AST when no equivalent element was identified in the other AST. That is, a non-equivalent element in the second AST may be an element that has no correspondence in the first AST or may be an element of the first AST that is missing in the second AST. In some implementations, the code analysis module 201 only records non-equivalencies. The equivalency map 207 may be used for validating the output source code 205.

The method of FIG. 2 also includes indicating 206, based on the equivalency mapping 207, a validation result 209 for the output source code. In some examples, the code analysis module 201 generates the validation result 209 based on the degree of the equivalency (including non-equivalency) indicated by the equivalency mapping. For example, the validation result may be a ranking of the output source code based on the number of non-equivalent elements that were discovered in the mapping 207. Alternatively, the validation result may be a score based on a ratio of non-equivalent elements to all of elements of the second AST. In some implementations, the code analysis module 201 determines whether the output source code passed validation if this rank or score is lower than a threshold. In other implementations, the validation result indicates a validation failure when the equivalency mapping indicates at least one nonequivalent element was found in either the first AST or the second AST, whereas the validation result indicates a validation success when the equivalency mapping indicates an equivalency for all elements of the first AST and the second AST. In these implementations, the output source code is successfully validated only if the structure of its AST is equivalent to that of the input source code. Thus, in some examples, indicating 206, based on the equivalency mapping 207, a validation result 209 for the output source code can include indicating, to a user or within a data structure, a validation result such as a pass/fail result, a ranking, a score, or other validation assessment. For example, the validation result may be indicated in a graphical user interface or command line interface.

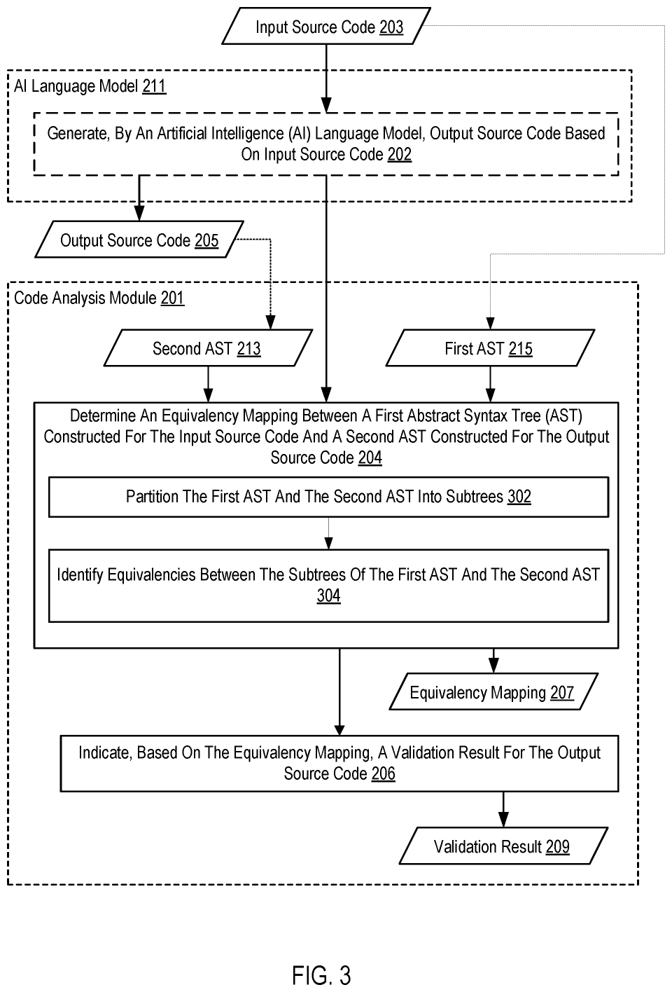

For further explanation, FIG. 3 sets forth a flowchart of an example method of validating code generated by artificial intelligence using abstract syntax trees in accordance with some embodiments of the present disclosure. The method of FIG. 3 extends the method of FIG. 2 in that determining 204 an equivalency mapping 207 between a first AST 213 constructed for the input source code 203 and a second AST 215 constructed for the output source code 205 includes partitioning 302 the first AST 213 and the second AST 215 into subtrees. For example, the ASTs may be partitioned into subtrees and nested subtrees of varying granularity. In some examples, the code analysis module 201 partitions 302 each AST 213, 215 by selecting a leaf node and walking up the tree until it locates a subtree root. What constitutes a subtree root may be predefined. For example, the subtree root may be given as any operator or expression, or the subtree root may be more explicitly defined as particular types of expressions such as, for example, decision points or function declarations. Once the subtree root is identified, that node and all nodes connected below it are grouped as a subtree.

As part of determining 204 the equivalency mapping, the code analysis module 201 also identifies 304 equivalencies between the subtrees of the first AST 213 and the second AST 215. In some examples, the code analysis module 201 identifies 304 equivalencies between the subtrees by iteratively selecting a subtree in one AST (e.g., AST 213) and mapping the first subtree to an equivalent subtree in another AST (e.g., the second AST 215). For example, the code analysis module 201 can walk the selected subtree, evaluate the type and/or properties of each node, and determine whether there is an equivalent subtree with equivalent nodes and structure in the other AST (e.g., the second AST 215). In some implementations, the code analysis module 201 further scores the equivalency, or otherwise flags the equivalency, between subtrees based on the presence of any non-equivalent elements (e.g., extra or missing nodes). Using these subtrees as building blocks, and by changing the positioning of subtrees, the code analysis module 201 can reconstruct, through iteration and recursion, the second AST 215 to be structurally identical to the first AST 213 (or the revere) such that any missing or additional element in either AST will be apparent.

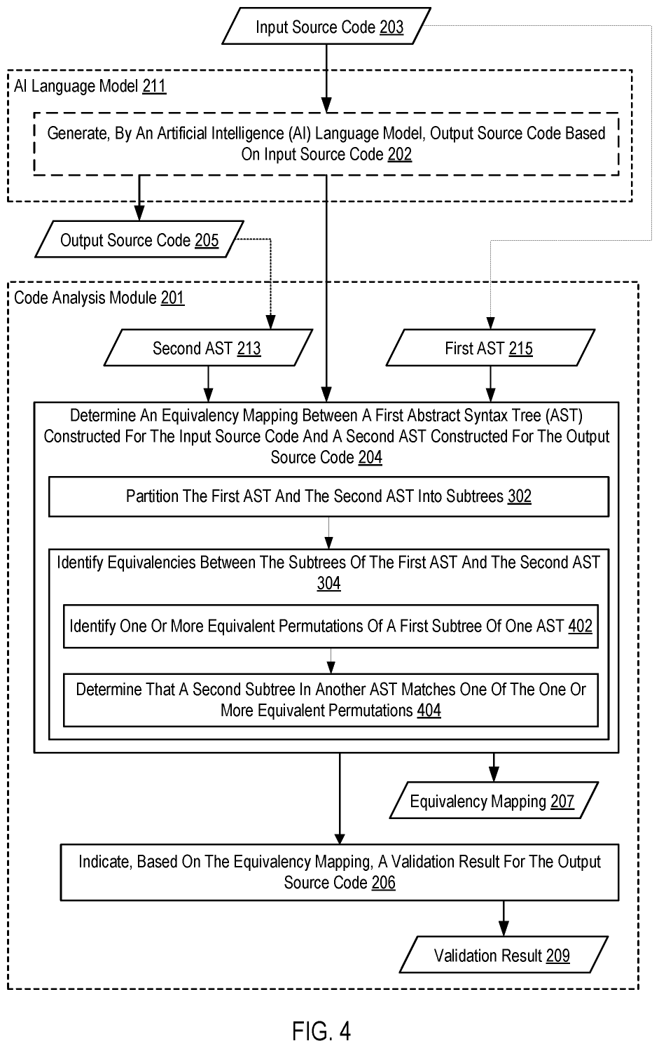

For further explanation, FIG. 4 sets forth a flowchart of an example method of validating code generated by artificial intelligence using abstract syntax trees in accordance with some embodiments of the present disclosure. The method of FIG. 4 extends the method of FIG. 3 in that the method of FIG. 4 in that identifying 304 equivalencies between the subtrees of the first AST 213 and the second AST 215 includes identifying 402 one or more equivalent permutations of a first subtree. When an exact match for a subtree cannot be identified, the code analysis module 201 may analyze functionally equivalent permutations of the subtree. In some examples, the code analysis module 201 identifies 402 one or more equivalent permutations of the first subtree by reordering independent statements, such as by swapping the position of two nodes. In such examples, if a swapped node is a subtree root, the position of the entire subtree is swapped. Consider an example where subtree S of tree X includes paths ordered as [{A, B, E}, {A, B, D, F, G}, {A, C}]. Permutations of this subtree include paths ordered as [{A, B, D, F, G}, {A, B, E}, {A, C}] by swapping nodes E and D or [{A,C}, {A, B, E}, {A, B, D, F, E}] by swapping nodes B and C, and so on. Although structurally different, these permutations are functionally identical. In other examples, identifying 402 one or more equivalent permutations of a first subtree can include altering variable names of nodes when it is ascertained that one node associated with a first variable name corresponds to another node associated with a different variable name, in that those nodes are functionally equivalent nodes.

As part of identifying 304 equivalencies between the subtrees of the first AST 213 and the second AST 215, the method of FIG. 4 also includes determining 404 that a second subtree in another AST matches one of the one or more permutations. In some examples, the code analysis module 201 determines 404 that a second subtree matches one of the permutations of the first subtree by walking the subtrees and comparing the types and properties of the nodes. Continuing the above example, the code analysis module 201 may determine that a subtree T in tree Y includes paths ordered as [{A, B, D, F}, {A, B, E}, {A, C}], which matches one of the permutations of subtree S in tree X.

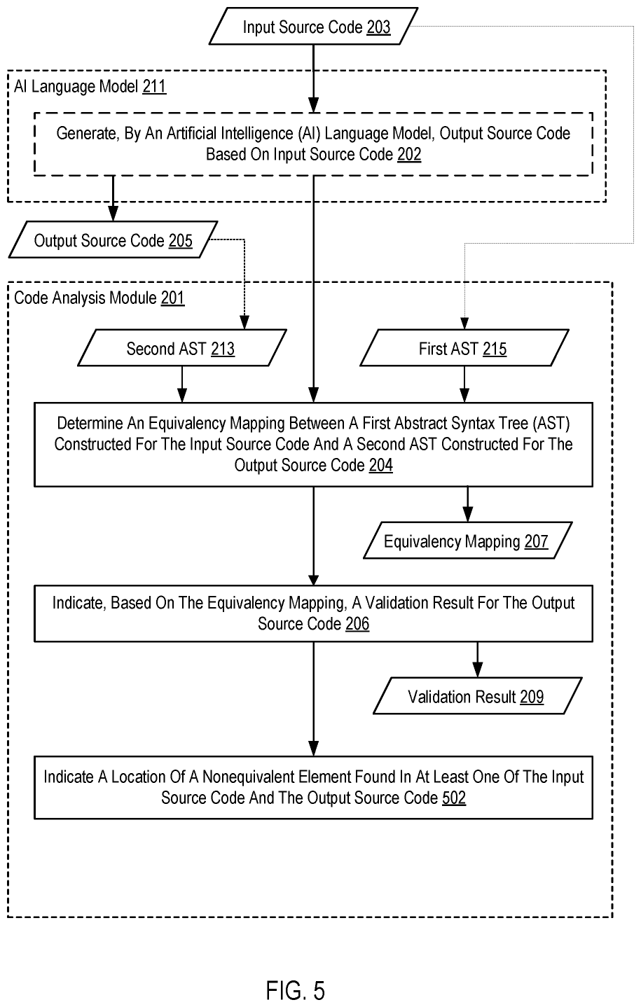

For further explanation, FIG. 5 sets forth a flowchart of an example method of validating code generated by artificial intelligence using abstract syntax trees in accordance with some embodiments of the present disclosure. The method of FIG. 5 extends the method of FIG. 2 in that the method of FIG. 5 further includes indicating 502 a location of a nonequivalent element found in at least one of the input source code and the output source code. In some cases, the code analysis module 201 will identify that the second AST 215 includes an element that does not correspond to an element in the first AST 213, or that the second AST 215 lacks an element that is present in the first AST 213. In such cases, the code analysis module 201 indicates 502 a location of the nonequivalent element by notating, highlighting, or otherwise calling attention to the portion of the output source code that includes the nonequivalent or absent element. For example, the code analysis module 201 may indicate a function that includes a missing statement or may call attention to an additional statement that was not found in the first AST 213. In some implementations. In some examples, the code analysis module 201 provides a validation analysis to a user interface. In such examples, the validation analysis may include the validation result as well as the locations in the output source code that include the nonequivalent or absent elements. In this way, a software engineer can examine the block of code and assess whether the additional or missing element is a critical error or merely a translation glitch.

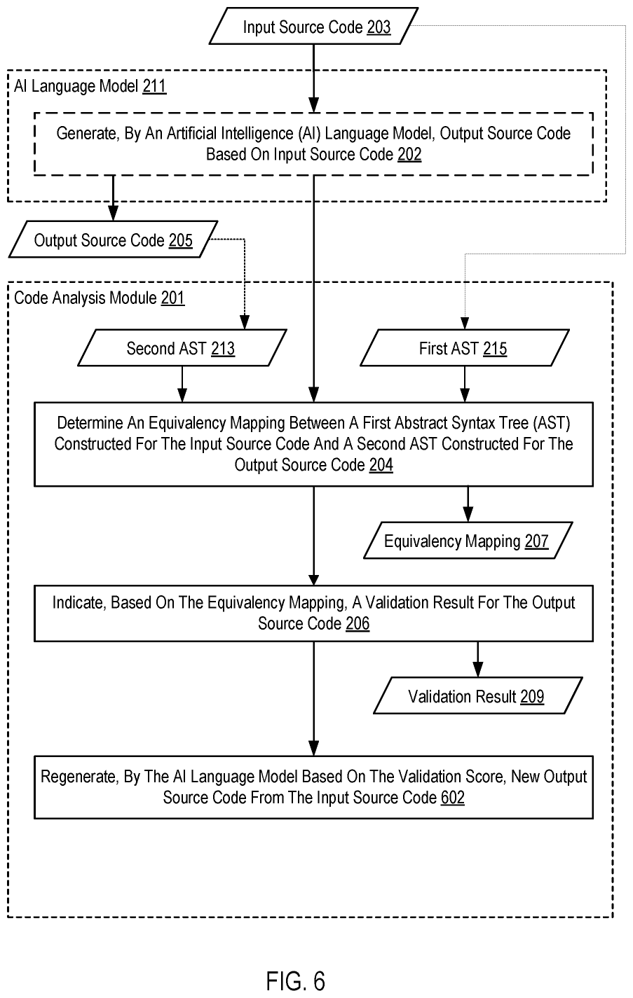

For further explanation, FIG. 6 sets forth a flowchart of an example method of validating code generated by artificial intelligence using abstract syntax trees in accordance with some embodiments of the present disclosure. The method of FIG. 6 extends the method of FIG. 2 in that the method of FIG. 6 further includes regenerating 602, by the AI language model 211 based on the validation result 209, the output source code 205 from the input source code 203. In some examples, the code analysis module 201 determines that the validation result 209 for the output source code indicates that the output source code has failed validation. Accordingly, the code analysis module 201 determines that the output source code, or some portion of the output source code, should be regenerated. In some examples, the code analysis module 201 generates a prompt much in the same manner as described above; however, in this instance the prompt indicates to the AI language model that the AI language model should generate a different implementation. In such a case, the code analysis module 201 may generate a prompt such as “Regenerate code for block A” or “Regenerate code for block A that is syntactically different from the previously generated code.” In response, the AI language model regenerates alternative code for the input code corresponding to block A. In some implementations, the code analysis module 201 iteratively re-prompts the AI language model 211 to regenerate new output source code from the input source code, for example, until the output source code passes validation or until a threshold number of attempts has been reached. In some examples, the code analysis module 201 may identify the block of code that relates to the nonequivalence and prompt the AI language model to regenerate only that block.

In some implementations, the code analysis module 201 adjusts one or more parameters of the AI language model before regenerating the output source code. The AI language model can include configurable parameters that influence the creativity of the model's response to a prompt. For example, a temperature parameter adjusts the distribution of probabilities that can be used to select the next token for an output stream. In selecting the next token for an output stream, a lower temperature causes the language model to select tokens whose probabilities are within a narrower range, tending to more deterministic output, while a higher temperature causes the language model to select tokens whose probabilities are within a wider range, tending to more random output. Another example parameter is a top k parameter that controls the randomness of selecting the next token by telling the language model that it must select from the top k highest probability tokens. Yet another example parameter is a top p parameter that controls the randomness of selecting the next token by telling the language model that it must select from the highest probability tokens whose probabilities sum to or exceed the p value.

In some examples, the code analysis module 201 adjusts one or more parameters of the AI language model in response to determining that one or more iterations of generating the output source code failed validation. For example, as the number of iterations increases, the parameters that control the creativity of the AI language model may be adjusted to increase the randomness of the output. In this way, the AI language model can be induced to generate a solution that is dissimilar to the failed solutions presented in previous iterations. In some examples, adjusting one or more parameters is carried out by including a statement in a prompt to adjust the parameter, such as “Set temperature to 0.8.”

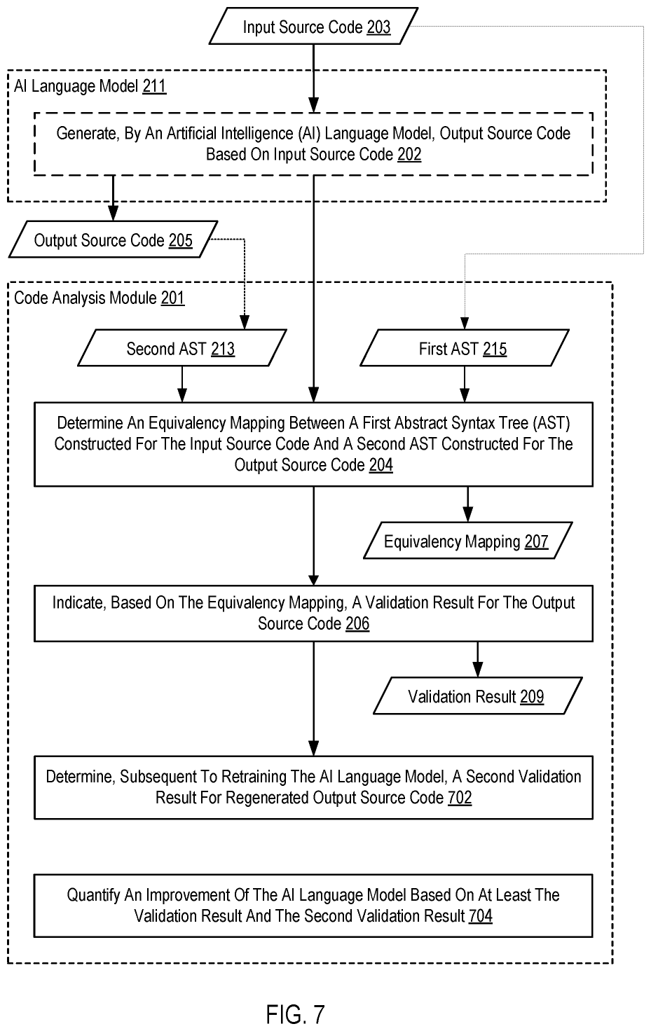

For further explanation, FIG. 7 sets forth a flowchart of an example method of validating code generated by artificial intelligence using abstract syntax trees in accordance with some embodiments of the present disclosure. The method of FIG. 6 extends the method of FIG. 2 in that the method of FIG. 6 further includes determining 702, subsequent to retraining the AI language model 211, a second validation result for regenerated output source code. In some examples, the AI language model 211 is retrained on additional training datasets to improve the quality of the AI code translations of input source code. To assess whether the AI language model has improved in the quality and an accuracy of the code translations, and to quantify the improvement, the AI model is prompted to regenerate output source code based on the input source code with which the validation score was previously determined. In these examples, the code analysis module 201 determines 702 the second validation result in the manner described above in generating the initial validation result 209.

The method of FIG. 6 also includes quantifying 704 an improvement of the AI language model 211 based on at least the validation result and the second validation result. In some examples, the code analysis module 201 quantifies 704 the improvement of the AI language model 211 by comparing the initial validation result 209 to the second validation result to determine whether the AI language model 211 is generating output source code that is structurally identical to the input source code.

While embodiments are useful in migrating or porting an application from one programming language to a different programming language, and from legacy programming language to a more modernized programming language, it will be appreciated that in some examples the original source code and the new source code may be written in the same programming language.

In view of the foregoing, validating code generated by artificial intelligence using abstract syntax trees in accordance with the present disclosure provides a number of advantages. Embodiments of the present disclosure improve the accuracy and quality of automated code generation, and further improve the reliability and maintainability of the source code generated through automated code generation, thus providing mechanisms to meet the challenges of validating AI-generated source code against the original source code. This provides a technical advantage to the field of automated code translation and to the fields of software development and maintenance as a whole. Consistent with these advantages, the comparison of the ASTs of the input source code and the output source code determines whether the input source code and output source code are functionally equivalent though the ASTs may exhibit a different structure. All permutations of core functions can be relationally mapped for AST comparison. Complex ASTs constructed from hundreds of thousands, if not millions, lines of code can be unitized for comparison, such that independent subtrees of one AST can be reordered to match the structure of the other AST to facilitate comparison and determine equivalency. Subtrees of different shapes but identical paths can be used to determine whether one tree is functionally equivalent to another subtree. This allows a rearrangement of elements in one AST to match the shape of the other AST. Based on the validation result of an initial generation of output source code, the AI language module can iteratively regenerate the output source code until an acceptable validation result is achieved. The validation result allows software engineers to analyze the translation error and determine whether the error (i.e., indicated by a non-equivalency in the AST) is a critical error. Engineers can further use the information to identify aspects for retraining the AI language model. Further, the accuracy and reliability of the AI language model can be quantified using the validation result and the effect of retraining the AI language model can be measured.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of validating code generated by artificial intelligence using abstract syntax trees comprising:
generating, by an artificial intelligence (AI) language model, output source code based on input source code;
determining an equivalency mapping between a first abstract syntax tree (AST) constructed for the input source code and a second AST constructed for the output source code; and
indicating, based on the equivalency mapping, a validation result for the output source code.

2. The method of claim 1, wherein the input source code is implemented in a first programming language and the output source code is implemented in a second programming language that is different from the first programming language.

3. The method of claim 1, wherein the validation result indicates a validation failure when the equivalency mapping indicates at least one nonequivalent element in at least one of the first AST and the second AST; and
wherein the validation result indicates a validation success when the equivalency mapping indicates an equivalency for all elements of the first AST and the second AST.

4. The method of claim 1, wherein the validation result indicates a degree of equivalency.

5. The method of claim 1, wherein determining an equivalency mapping between a first AST constructed for the input source code and a second AST constructed for the output source code includes:
partitioning the first AST and the second AST into subtrees; and
identifying equivalencies between the subtrees of the first AST and the second AST.

6. The method of claim 5, wherein identifying equivalencies between the subtrees of the first AST and the second AST includes:
identifying one or more equivalent permutations of a first subtree of one AST; and
determining that a second subtree in another AST matches one of the one or more equivalent permutations.

7. The method of claim 6, wherein the one or more equivalent permutations of the first subtree are generated by one or more of changing variable names and reordering independent statements.

8. The method of claim 1 further comprising:
indicating a location of a nonequivalent element found in at least one of the input source code and the output source code.

9. The method of claim 1 further comprising:
regenerating, by the AI language model in response to the validation result, new output source code from the input source code.

10. The method of claim 1 further comprising:
determining, subsequent to retraining the AI language model, a second validation result for regenerated output source code; and
quantifying an improvement of the AI language model based on at least the validation result and the second validation result.

11. An apparatus comprising:
a memory; and
a processing device, operatively coupled to the memory, the processing device configured to:
generate, by an artificial intelligence (AI) language model, output source code based on input source code;
determine an equivalency mapping between a first abstract syntax tree (AST) constructed for the input source code and a second AST constructed for the output source code; and
indicate, based on the equivalency mapping, a validation result for the output source code.

12. The apparatus of claim 11, wherein to determine an equivalency mapping between a first AST constructed for the input source code and a second AST constructed for the output source code the processing device is configured to:
partition the first AST and the second AST into subtrees; and
identify equivalencies between the subtrees of the first AST and the second AST.

13. The apparatus of claim 12, wherein to identify equivalencies between the subtrees of the first AST and the second AST the processing device is configured to:
identify one or more equivalent permutations of a first subtree of one AST; and
determine that a second subtree in another AST matches one of the one or more equivalent permutations.

14. The apparatus of claim 11, wherein the processing device is further configured to:
indicate a location of a nonequivalent element found in at least one of the input source code and the output source code.

15. The apparatus of claim 11, wherein the processing device is further configured to:
regenerate, by the AI language model in response to the validation result, new output source code from the input source code.

16. The apparatus of claim 11, wherein the processing device is further configured to:
determine, subsequent to retraining the AI language model, a second validation result for regenerated output source code; and
quantify an improvement of the AI language model based on at least the validation result and the second validation result.

17. A non-transitory computer-readable storage medium storing instructions which, when executed, cause a processing device to:
determine an equivalency mapping between a first abstract syntax tree (AST) constructed for input source code and a second AST constructed for output source code, wherein the output source code is generated by an artificial intelligence (AI) language model based on the input source code; and
indicate, based on the equivalency mapping, a validation result for the output source code.

18. The computer-readable storage medium of claim 17, wherein the input source code is implemented in a first programming language and the output source code is implemented in a second programming language that is different from the first programming language.

19. The computer-readable storage medium of claim 17, wherein to determine an equivalency mapping between a first AST constructed for the input source code and a second AST constructed for the output source code the processing device is configured to:
partition the first AST and the second AST into subtrees; and
identify equivalencies between the subtrees of the first AST and the second AST.

20. The computer-readable storage medium of claim 17, wherein the processing device is further configured to:
determine, subsequent to retraining the AI language model, a second validation result for regenerated output source code; and
quantify an improvement of the AI language model based on at least the validation result and the second validation result.
